(19) United States
(12) Patent Application Publication
(10) Pub. No.: US 2026/0205280 A1
(43) Pub. Date: Jul. 16, 2026

(54) VIBRATION-INDUCED, POST-QUANTUM ENCRYPTION SYSTEM USING CYMATICS-BASED KEY GENERATION

(71) Applicant: PURUSHOTHAMA RAJ, Chennai (IN)

(72) Inventor: PURUSHOTHAMA RAJ, Chennai (IN)

(21) Appl. No.: 19/303,413

(22) Filed: Aug. 19, 2025

(30) Foreign Application Priority Data
Oct. 25, 2024 (IN) 202441081297

(51) Int. Cl. H04L 9/08

(52) U.S. Cl. CPC H04L 9/0852

(57) ABSTRACT

A post-quantum encryption system utilizes cymatics patterns formed in a liquid medium (102) for high-entropy cryptographic key generation. The system includes a container (101) holding the liquid medium, and one or more vibration sources (105) configured to generate acoustic waves that induce dynamic ripple formations. A temperature control unit (106) adjusts the medium's thermal state to modulate waveform complexity. Sensors (107), including high-speed imaging units (108) and interferometric sensors (109), capture wave patterns in real-time. A signal processing module extracts parameters such as amplitude, wavelength, and frequency, which are converted into a cryptographic key via a secure interface. The key may be used in symmetric, asymmetric, or post-quantum algorithms. Optionally, a quantum key distribution (QKD) module (127) transmits the generated key securely. The invention leverages physical randomness and acoustic-fluid dynamics to provide scalable, tamper-resistant encryption suitable for next-generation security infrastructure.

### CROSS-REFERENCE TO RELATED APPLICATIONS

Claiming priority of the Indian Application 202441081297 titled NOISE/SOUND-INDUCED, POST-QUANTUM ENCRYPTION filed on Oct. 25, 2024 of which are incorporated herein by reference in their entireties.

### STATEMENT REGARDING FEDERALLY SPONSORED RESEARCH OR DEVELOPMENT

Not applicable.

(Include only if the invention was developed with U.S. Government support.)

### FIELD OF THE INVENTION

The invention relates to the field of data encryption and cybersecurity. More particularly, it pertains to a system and method for generating cryptographic keys through physical phenomena specifically, cymatics wave patterns generated by sound-induced ripples in a liquid medium.

### BACKGROUND OF THE INVENTION

In the modern era of digital communications, the security of transmitted and stored data is paramount. Conventional encryption systems such as RSA, ECC, and AES rely heavily on computational hardness assumptions such as the difficulty of prime factorization, discrete logarithms, or lattice problems for the generation and protection of encryption keys. While effective under current computational paradigms, these techniques face significant limitations in the face of rapidly advancing technologies, particularly quantum computing. With the advent of quantum algorithms like Shor's and Grover's, the cryptographic community is confronted with the realization that encryption schemes such as RSA-2048 and ECC could be rendered obsolete once practical quantum computers become operational. Shor's algorithm, for instance, can factor large integers in polynomial time, thereby dismantling the foundational security assumption behind RSA.

Equally concerning is the reliance on pseudo-random number generators (PRNGs) in current systems. PRNGs are deterministic by nature and often seeded using system states that may be exposed or predicted, such as timestamps or process IDs. Once compromised, these seeds allow adversaries to regenerate encryption keys or authentication tokens. Even advanced deterministic generators, when observed or reverse-engineered under side-channel attacks, have shown vulnerabilities. In side-channel attacks, adversaries exploit physical manifestations such as timing variations, power consumption, or electromagnetic leakage to infer sensitive cryptographic material.

Numerous research efforts and patent disclosures have attempted to improve entropy sources by exploring hardware-assisted or natural phenomena. For example, U.S. Pat. No. 9,853,933B2 discloses chaotic circuit-based random number generators, leveraging analog signal unpredictability. However, such designs are primarily confined to electrical noise and remain sensitive to environmental interference and calibration requirements. US20170304643A1 suggests entropy derivation from sensor noise such as image sensors, but its quality is bounded by hardware resolution and noise modelling. WO2018217325A1 explores optical quantum key generation, yet these systems are often too complex, requiring precise alignment, photon emitters, and receivers, which limits their deploy ability in mainstream infrastructures.

A fundamental limitation across these approaches is their dependence on micro-scale or quantum-scale phenomena which, while theoretically secure, are often difficult to scale, interpret, or monitor for entropy assurance. In contrast, the proposed invention leverages macro-level, observable physical phenomena specifically, the ripple patterns formed in a liquid medium by sound waves. This concept draws from the principles of cymatics, a scientific field that studies visible sound vibrations. In this context, the invention introduces an entirely different entropy model based on naturally emergent, visually complex, and unpredictable wave patterns generated by acoustic energy.

The uniqueness of this invention lies in its use of real-time, environmental dynamics—modulated by sound frequency, liquid viscosity, container geometry, and temperature variation—to generate entropy. These parameters create a highly sensitive and non-replicable system in which even small variations in input can drastically alter the resultant waveform. The chaotic interaction of these variables leads to extremely high entropy, which can be harnessed to generate cryptographic keys that are not mathematically derived but instead physically captured and numerically translated.

This system fills multiple gaps in the existing encryption landscape. Firstly, it provides a true entropy source that is neither deterministic nor subject to reverse engineering via mathematical analysis. Secondly, it introduces a physical key generation process that is decoupled from processor-based computation, thereby neutralizing threats from quantum decryption algorithms. Thirdly, it proposes a scalable and modular solution using accessible components like piezoelectric speakers, fluid containers, and optical sensors. Unlike quantum-optical systems, this approach does not necessitate fragile alignment, vacuum environments, or photon counting, thereby making it more feasible for broader adoption.

Furthermore, the invention integrates seamlessly with both symmetric and asymmetric cryptographic protocols, including post-quantum algorithms such as lattice-based, code-based, multivariate polynomial-based, and hash-based schemes. The system can serve as a key seed input or directly replace conventional key generators. Its integration with quantum key distribution (QKD) modules, though optional, adds an additional layer of secure key transport, ensuring that the entropy-rich key is not compromised in transmission.

In conclusion, the present invention not only introduces a novel key generation paradigm based on cymatics physical phenomena but also addresses several open problems in cryptography. These include the generation of unpredictable and high-entropy keys, quantum-resilient architectures, hardware accessibility, and seamless cryptographic system integration. This invention represents a tangible shift from purely algorithmic encryption systems toward hybrid models that incorporate real-world, physical complexity as a shield against emerging cybersecurity threats.

### SUMMARY OF THE INVENTION

The following summary is provided to facilitate a clear understanding of the new features in the disclosed embodiment and it is not intended to be a full, detailed description. A detailed description of all the aspects of the disclosed invention can be understood by reviewing the full specification, the drawing and the claims and the abstract, as a whole.

The present invention proposes a post-quantum encryption system that innovatively derives encryption keys from the complex, dynamic wave patterns created by sound-induced vibrations in a liquid medium. These waveforms, formed by the interaction of acoustical energy with a fluid body, possess inherent randomness and complexity due to the interplay of frequency, amplitude, fluid viscosity, container shape, and temperature. The unpredictability of these ripple patterns introduces a high degree of entropy, making them an ideal source for secure cryptographic key material.

The invention utilizes a specially engineered apparatus that includes a fluid-holding container, one or more vibration generators, and an array of sensors to capture the resulting waveforms. These components work in concert to generate and record the cymatics patterns with high temporal and spatial resolution. Once captured, the patterns are analysed using signal processing modules to extract relevant features such as amplitude, wavelength, frequency, phase shift, and wave propagation direction. These parameters are then converted into digital values using mathematical transformations, neural networks, or evolutionary algorithms, and ultimately compiled into a cryptographically secure key.

Unlike traditional systems that depend on software-based pseudo-random number generation, the proposed invention employs physical phenomena that are not subject to deterministic reconstruction. The system's reliance on naturally chaotic wave interactions ensures that even minor changes in input variables such as sound frequency or liquid temperature can lead to significantly different outputs, thus amplifying security and resistance to brute-force or pattern-based attacks.

The cryptographic key derived from the ripple data can be applied to both symmetric and asymmetric encryption algorithms, as well as emerging post-quantum cryptographic schemes. The system is designed to be modular and compatible with existing security infrastructures. Moreover, it includes optional integration with quantum key distribution (QKD) protocols, enabling the secure transmission of generated keys across communication networks.

In essence, the invention provides a transformative approach to encryption, grounded in physical randomness and fluid acoustics. It introduces a reliable, scalable, and tamper-resistant method for key generation that not only enhances present-day data security but also anticipates and mitigates future threats posed by quantum computing. By bridging the gap between physical unpredictability and digital security, this invention offers a robust, future-proof framework for protecting sensitive information in a variety of critical applications.

### BRIEF DESCRIPTION OF THE DRAWINGS

The manner in which the present invention is formulated is given a more particular description below, briefly summarized above, may be had by reference to the components, some of which is illustrated in the appended drawing It is to be noted; however, that the appended drawing illustrates only typical embodiments of this invention and are therefore should not be considered limiting of its scope, for the system may admit to other equally effective embodiments.

Throughout the drawings, the same drawing reference numerals will be understood to refer to the same elements and features.

The features and advantages of the present invention will become more apparent from the following detailed description a long with the accompanying figures, which forms a part of this application and in which:

FIG. 1: Top View of the apparatus in accordance with our present invention;

FIG. 2: Front suspended view of the apparatus in accordance with our present invention;

FIG. 3: Isometric view of apparatus in accordance with our present invention;

FIG. 4: Inverted view 1 of apparatus in accordance with our present invention;

FIG. 5: Inverted View 2 of apparatus in accordance with our present invention;

FIG. 6: Liquid/solid medium holding plate in accordance with our present invention;

FIG. 7: Vibration Speaker in accordance with our present invention;

FIG. 8: Vibration speaker side view in accordance with our present invention;

FIG. 9: Vibration speaker bottom view in accordance with our present invention;

FIG. 10: Vibration speaker cross section in accordance with our present invention;

FIG. 11: Displays a futuristic view of how the system looks in accordance with our present invention;

### DETAILED DESCRIPTION OF THE FIGURES

### Figure Details

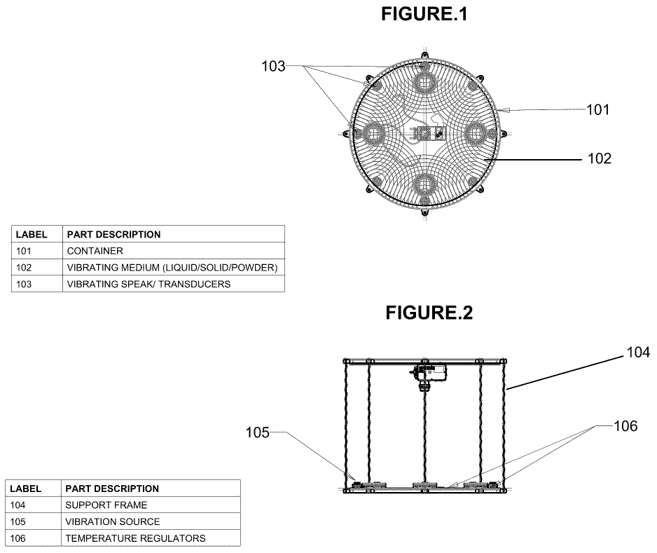

FIG. 1 shows a top view of the encryption apparatus in which the main open-top container (101) is clearly visible and centrally located. This container is configured to hold the liquid medium (102) used for generating cymatics patterns. Surrounding the periphery of the container are multiple transducers mounting points (103), which are precisely positioned to uniformly introduce vibrations into the fluid medium.

FIG. 2 provides a front suspended view of the apparatus. The structural support frame (104) can be seen suspending the vibration source (105) directly above the fluid surface (102), ensuring vertical alignment. Beneath the container (101), a temperature control unit (106) is placed in contact with the base surface, allowing regulated heating or cooling of the medium to modulate fluid properties such as viscosity and density.

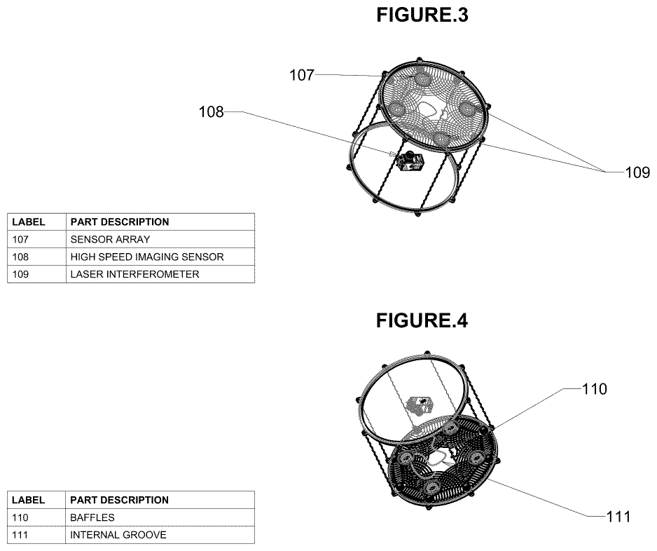

FIG. 3 illustrates an isometric perspective of the full system, revealing the placement of the sensor array (107) around the container (101). This sensor array includes both high-speed imaging sensors (108) for capturing ripple dynamics and laser interferometers (109) for measuring sub-millimetre displacement or oscillation on the fluid surface.

FIG. 4 depicts an inverted view of the container, emphasizing the internal structures responsible for shaping wave propagation. The view exposes baffles (110) aligned perpendicular to the container walls, designed to reflect and refract waves. Also visible are internal grooves (111) embedded along the inner surface to introduce irregular flow and perturbations in the ripple pattern.

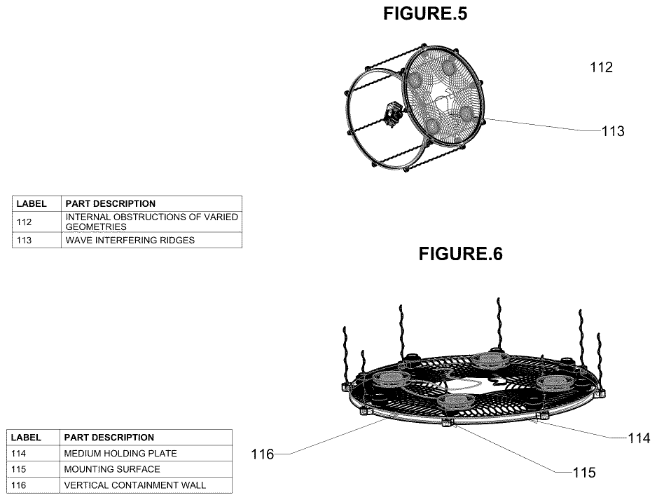

FIG. 5 gives an alternative inverted view, where internal obstructions (112) of varied geometries are placed on the container's floor to deliberately interrupt uniform wave paths. Additionally, wave-interfering ridges (113) are included in a radiating layout to further increase the spatial complexity of the resultant patterns.

FIG. 6 illustrates the medium holding plate (114), which supports both liquid and semi-viscous substances depending on the use case. The base is a resilient mounting surface (115) designed to dampen external vibrations, while the vertical containment wall (116) ensures the medium remains uniformly distributed and stable during experimentation.

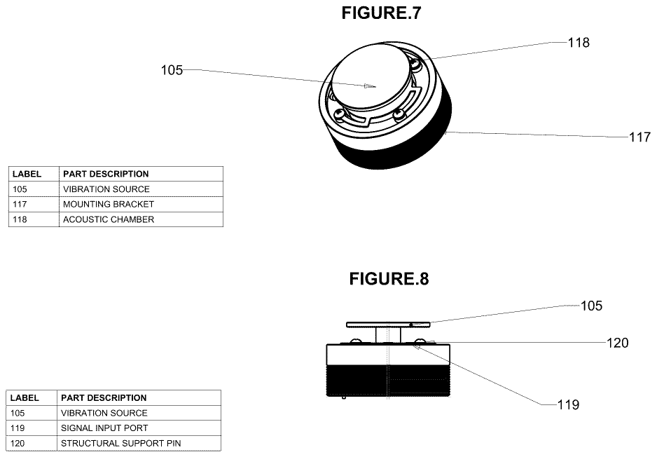

FIG. 7 presents a detailed view of the primary vibration speaker (105), which is the sound source used to excite the fluid. Attached to it is a secure mounting bracket (117), and enclosing the speaker is an acoustic chamber (118) that helps focus and direct sound energy downward into the medium.

FIG. 8 shows the side profile of the same speaker (105), where dual signal input ports (119) are visible, enabling dynamic control of input frequencies. Structural support fins (120) on the sides help stabilize the unit when mounted to the containment system.

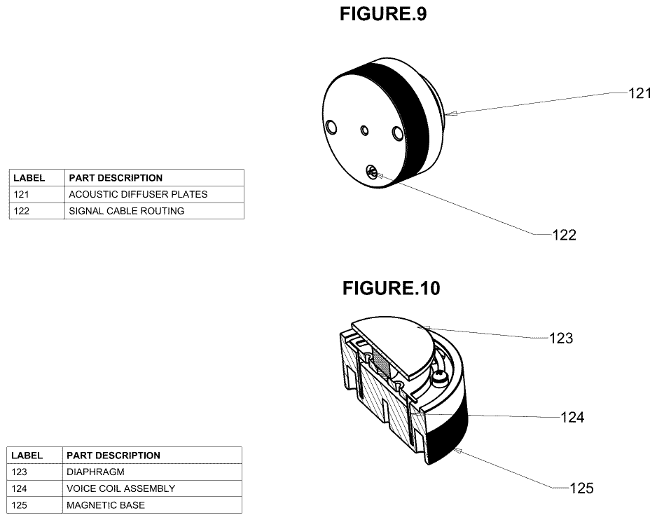

FIG. 9 details the bottom view of the vibration speaker, with clearly defined acoustic diffuser plates (121) responsible for even distribution of sound waves. The arrangement of signal cable routing paths (122) ensures clean, non-intrusive wiring that avoids interference with wave behaviour.

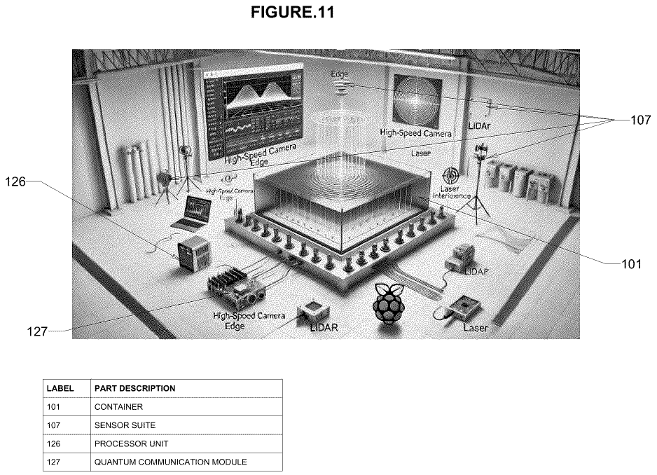

FIG. 10 offers a cross-sectional depiction of the vibration speaker (105). Internal components such as the vibrating diaphragm (123), voice coil assembly (124), and magnetic base (125) are labelled, showing how sound is generated and directed toward the liquid container in a controlled manner.

FIG. 11 provides a futuristic and integrated view of the complete system in operation. It shows the liquid container (101) surrounded by the sensor suite (107), which feeds data into a processing unit (126). In the same schematic, a quantum communication module (127) is connected, signifying the system's readiness for integration with secure QKD infrastructure.

This detailed embodiment ensures the system operates at high entropy and high reproducibility while maintaining a cost-effective and scalable hardware configuration suitable for both commercial and military-grade cryptographic applications.

FIG. 1 illustrates a top view of the encryption apparatus, highlighting the open-top container (101) designed to hold the liquid medium (102). The transducer mounting points (103) are located around the perimeter to introduce vibrations.

FIG. 2 shows a front suspended view of the apparatus, where the support frame (104) holds the vibration source (105) above the liquid surface (102), and the temperature control unit (106) is positioned below the container (101).

FIG. 3 presents an isometric view of the apparatus, depicting the sensor array (107) around the container (101), which includes high-speed imaging sensors (108) and laser interferometers (109).

FIG. 4 provides an inverted view of the apparatus showing the placement of baffles (110) and internal surface grooves (111) that shape the liquid wave patterns.

FIG. 5 is another inverted perspective emphasizing the arrangement of internal obstructions (112) and wave-interfering ridges (113) on the container base.

FIG. 6 details the liquid/solid medium holding plate (114), showing the resilient mounting base (115) and fluid-retaining wall (116).

FIG. 7 displays the vibration speaker (105) used for producing controlled frequency waves, including its mounting bracket (117) and acoustic chamber (118).

FIG. 8 gives a side view of the vibration speaker (105), where the signal input ports (119) and structural support fins (120) are visible.

FIG. 9 presents a bottom view of the same speaker unit, showing acoustic diffuser plates (121) and signal cable routing (122).

FIG. 10 illustrates a cross-sectional view of the speaker, revealing the diaphragm (123), voice coil assembly (124), and magnetic base (125).

FIG. 11 provides a futuristic conceptual view of the entire system, integrating the container (101), sensor suite (107), processor unit (126), and a quantum communication module (127) for end-to-end secure data handling.

### DETAILED DESCRIPTION OF THE INVENTION

The principles of operation, design configurations and evaluation values in these non-limiting examples can be varied and are merely cited to illustrate at least one embodiment of the invention, without limiting the scope thereof.

The embodiments disclosed herein can be expressed in different forms and should not be considered as limited to the listed embodiments in the disclosed invention. The various embodiments outlined in the subsequent sections are constructed such that it provides a complete and a thorough understanding of the disclosed invention, by clearly describing the scope of the invention, for those skilled in the art. Throughout this specification various indications have been given as to preferred and alternative embodiments of the invention. It should be understood that it is the appended claims, including all equivalents, which are intended to define the spirit and scope of this invention.

The present invention discloses a system and method for generating encryption keys using complex wave patterns formed by sound-induced vibrations in a liquid medium. These patterns arise from the interaction of acoustic energy with fluid properties such as viscosity, surface tension, and temperature, within a geometrically defined container. The invention is aimed at enhancing cryptographic security by providing a novel entropy source that is inherently unpredictable and resistant to quantum computing threats.

The system comprises a specialized container designed to hold a liquid medium. The container may be constructed from acoustically responsive materials such as glass, acrylic, or polymers, which allow for effective transmission and visualization of vibrations. Its internal geometry, which may include baffles, obstructions, or textured surfaces, is engineered to manipulate the propagation of acoustic waves, resulting in diverse and non-repetitive waveforms.

Vibration is introduced into the liquid medium through one or more transducers, such as piezoelectric speakers or electromagnetic actuators. These devices are capable of emitting sound across a wide range of frequencies, from low audio to ultrasonic bands. The acoustic signal may be modulated in frequency, amplitude, and phase, and can be controlled independently for each transducer to generate interference patterns or standing waves. The variability and complexity of input parameters contribute significantly to the unpredictability of the resulting waveforms.

The temperature of the medium is controlled through thermal regulation mechanisms such as thermoelectric coolers, heaters, or circulating fluid jackets. Changes in temperature directly influence the fluid's physical properties, which in turn alter wave behaviour. By precisely adjusting the temperature, additional layers of randomness can be introduced into the system, enhancing the entropy of the generated patterns.

These dynamically evolving patterns are captured using high-resolution imaging and sensing systems. Devices such as high-speed cameras, laser interferometers, and ultrasonic sensors record the changes on the fluid surface and within its volume. Optical systems may record thousands of frames per second, ensuring that even fleeting or chaotic ripple events are documented. The recorded data is processed in real time or batch mode using dedicated digital signal processors, FPGAs, or high-performance computing systems.

The data processing phase involves extracting numerical parameters from the captured patterns. These include amplitude, frequency, phase distribution, propagation velocity, wavelength, and spatial deformation. Algorithms such as Fourier transforms, wavelet analysis, and neural networks are used to characterize and quantify these features. The parameters are then converted into a sequence of numbers through mathematical transformations and entropy optimization routines, which may involve techniques like principal component analysis or genetic algorithms.

This sequence of numbers is compiled into a bitstream that serves as a cryptographic key or key seed. The generated key can be directly used in symmetric encryption schemes like AES, or further processed to derive asymmetric key pairs for RSA, ECC, or post-quantum cryptographic algorithms such as those based on lattices or multivariate polynomials. The system supports software and hardware integration through APIs or embedded interfaces to cryptographic modules and security processors.

In advanced implementations or other embodiments of our present invention, the invention includes a quantum key distribution (QKD) unit for transmitting the generated keys across secure optical channels. This ensures that any attempt to intercept the key during transit is detectable and can be addressed. QKD integration further positions our present invention as a forward-compatible solution for next-generation cryptographic infrastructures.

An example of one embodiment of our present invention involves an acrylic container with internal baffles filled with distilled water, three piezoelectric transducers mounted at orthogonal angles, and a thermoelectric jacket to maintain a constant 25° C. temperature. The transducers are driven by independently controlled waveform generators operating between 10 kHz and 40 kHz. A monochrome high-speed camera records top-down views at 4,000 frames per second. The video stream is analysed by a DSP using wavelet decomposition and entropy classification algorithms. Patterns meeting the randomness threshold are converted into 256-bit keys, which are directly loaded into an AES-256 engine for real-time encryption. A receiving unit with synchronized acoustic and thermal conditions regenerates the same key locally, enabling secure communication without explicit key exchange.

I claim:

1. A post-quantum encryption system comprising:
a container (101) configured to hold a liquid medium (102);
one or more vibration sources (105) operatively coupled to the container and configured to generate acoustic waves in the liquid medium;
a temperature control unit (106) thermally coupled to the container to vary the temperature of the liquid medium; one or more sensors (107) arranged to capture wave patterns generated in the liquid medium, wherein the sensors comprise high-speed imaging sensors (108) and interferometric sensors (109);
a signal processing module configured to extract entropy from the captured wave patterns using signal processing algorithms; and
a cryptographic interface configured to convert the extracted entropy into a cryptographic key, wherein said key is suitable for use with symmetric, asymmetric, or post-quantum cryptographic algorithms.

2. The system as claimed in claim 1, wherein the container (101) includes internal structures selected from baffles (110), grooves (111), ridges (113), and obstructions (112) to enhance waveform complexity.

3. The system as claimed in claim 1, wherein the vibration source (105) is selected from piezoelectric transducers, electromagnetic speakers, or resonating actuators, and is capable of emitting frequencies between 20 Hz and 100 kHz.

4. The system as claimed in claim 1, wherein the temperature control unit (106) includes thermoelectric modules or immersion heaters configured to induce temperature gradients in the liquid medium.

5. The system as claimed in claim 1, wherein the signal processing module includes a digital signal processor (DSP), field-programmable gate array (FPGA), or neural network for performing feature extraction and entropy evaluation.

6. The system as claimed in claim 1, wherein the extracted features include amplitude, frequency, wavelength, phase shift, propagation speed, and pattern interference metrics.

7. The system as claimed in claim 1, wherein the cryptographic interface further comprises a cryptographic key generator that outputs a 256-bit key using hash-based transformation of extracted entropy.

8. The system as claimed in claim 1, wherein the system is configured to operate in synchronization with a remote system having a substantially identical configuration to reproduce the same cryptographic key based on matched input parameters.

9. The system as claimed in claim 1, wherein the cryptographic interface supports post-quantum key algorithms including lattice-based encryption, code-based encryption, or multivariate polynomial encryption.

10. The system as claimed in claim 1, further comprising a quantum key distribution (QKD) module (127) configured to transmit the generated key over a quantum-secure communication channel.
